(19) United States
(12) Patent Application Publication
(10) Pub. No.: US 2026/0073412 A1
(43) Pub. Date: Mar. 12, 2026

(54) INFORMATION PROCESSING SYSTEM, INFORMATION PROCESSING METHOD, AND RECORDING MEDIUM

(71) Applicant: NEC Corporation, Tokyo (JP)

(72) Inventors: Yudai YAMAGUCHI, Tokyo (JP); Izumi KUWATA, Tokyo (JP); Miki TANAKA, Tokyo (JP)

(73) Assignee: NEC Corporation, Tokyo (JP)

(21) Appl. No.: 19/313,160

(22) Filed: Aug. 28, 2025

(30) Foreign Application Priority Data
Sep. 9, 2024 (JP) 2024-155193

(51) Int. Cl. G06Q 30/0202; G06F 40/40

(52) U.S. Cl. CPC G06Q 30/0202; G06F 40/40

(57) ABSTRACT

An information processing system includes an index acquisition unit that acquires an index for managing accuracy of demand prediction related to an object segment including a plurality of products handled by an object company, an intra-company information acquisition unit that acquires intra-company information related to the object segment inside the object company, an extra-company information acquisition unit that acquires extra-company information related to the object segment outside the object company, and an interpretation example generation unit that generates, as an interpretation example of the index, a sentence including a factor based on the intra-company information and the extra-company information related to an error of the demand prediction, by using a large language model.

This application is based upon and claims the benefit of priority from Japanese Patent Application No. 2024-155193, filed on Sep. 9, 2024, the disclosure of which is incorporated herein in its entirety by reference.

### TECHNICAL FIELD

The present disclosure relates to an information processing system, an information processing method, and a recording medium.

### BACKGROUND ART

In recent years, it is important to perform demand prediction of products. For example, JP 2015-118412 A describes a technology of predicting demand for a component to be predicted by using a model constructed based on past operation number data and operation time data related to a device having the component and the past delivery result number of the component.

### SUMMARY

An exemplary object of the present disclosure is to provide a technology of supporting analysis of an error of demand prediction in a segment.

An information processing system according to an exemplary aspect of the present disclosure includes index acquisition means for acquiring an index for managing accuracy of demand prediction related to an object segment including a plurality of products handled by an object company, intra-company information acquisition means for acquiring intra-company information related to the object segment inside the object company, extra-company information acquisition means for acquiring extra-company information related to the object segment outside the object company, and interpretation example generation means for generating, as an interpretation example of the index, a sentence including a factor based on the intra-company information and the extra-company information related to an error of the demand prediction, by using a large language model.

An information processing method according to an exemplary aspect of the present disclosure includes index acquisition processing in which at least one processor acquires an index for managing accuracy of demand prediction related to an object segment including a plurality of products handled by an object company, intra-company information acquisition processing in which the at least one processor acquires intra-company information related to the object segment inside the object company, extra-company information acquisition processing in which the at least one processor acquires extra-company information related to the object segment outside the object company, and interpretation example generation processing in which the at least one processor generates, as an interpretation example of the index, a sentence including a factor based on the intra-company information and the extra-company information related to an error of the demand prediction, by using a large language model.

A non-transitory recording medium recording an information processing program according to an exemplary aspect of the present disclosure causes at least one processor to execute index acquisition processing of acquiring an index for managing accuracy of demand prediction related to an object segment including a plurality of products handled by an object company, intra-company information acquisition processing of acquiring intra-company information related to the object segment inside the object company, extra-company information acquisition processing of acquiring extra-company information related to the object segment outside the object company, and interpretation example generation processing of generating, as an interpretation example of the index, a sentence including a factor based on the intra-company information and the extra-company information related to an error of the demand prediction, by using a large language model.

### BRIEF DESCRIPTION OF THE DRAWINGS

FIG. 1 is a block diagram illustrating a configuration of an information processing system according to the present disclosure;

FIG. 2 is a flowchart illustrating a flow of an information processing method according to the present disclosure;

FIG. 3 is a block diagram illustrating a configuration of an information processing system according to the present disclosure;

FIG. 4 is a block diagram illustrating a configuration of an information processing device according to the present disclosure;

FIG. 5 is a block diagram illustrating a configuration of a user terminal according to the present disclosure;

FIG. 6 is a flowchart illustrating a flow of an information processing method according to the present disclosure;

FIG. 7 is a diagram illustrating an example of a screen according to the present disclosure; and

FIG. 8 is a block diagram illustrating a hardware configuration of a computer that functions as each of the above devices.

### EXAMPLE EMBODIMENT

Hereinafter, example embodiments of the present disclosure will be exemplified. However, the present disclosure is not limited to the following example embodiments, and various modifications can be made within a scope described in the claims. For example, example embodiments obtained by appropriately combining technologies (some or all of things or methods) adopted in the following example embodiments can also be included in the scope of the present disclosure. Example embodiments obtained by appropriately omitting some of the technologies adopted in the following example embodiments can also be included in the scope of the present disclosure. Effects mentioned in the following example embodiments are examples of effects expected in the example embodiments, and do not define extension of the present disclosure. In other words, example embodiments that do not provide the effects mentioned in the following example embodiments can also be included in the scope of the present disclosure.

### FIRST EXAMPLE EMBODIMENT

A first example embodiment that is an example of the example embodiments of the present disclosure will be described in detail with reference to the drawings. The present example embodiment is a basic form of each example embodiment to be described below. An application range of each technology adopted in the present example embodiment is not limited to the present example embodiment. In other words, each technology adopted in the present example embodiment can also be adopted in another example embodiment included in the present disclosure within a range in which no particular technical problem occurs. Each technology illustrated in the drawings referred to for describing the present example embodiment can also be adopted in another example embodiment included in the present disclosure within a range in which no particular technical problem occurs.

### (Configuration of Information Processing System 1)

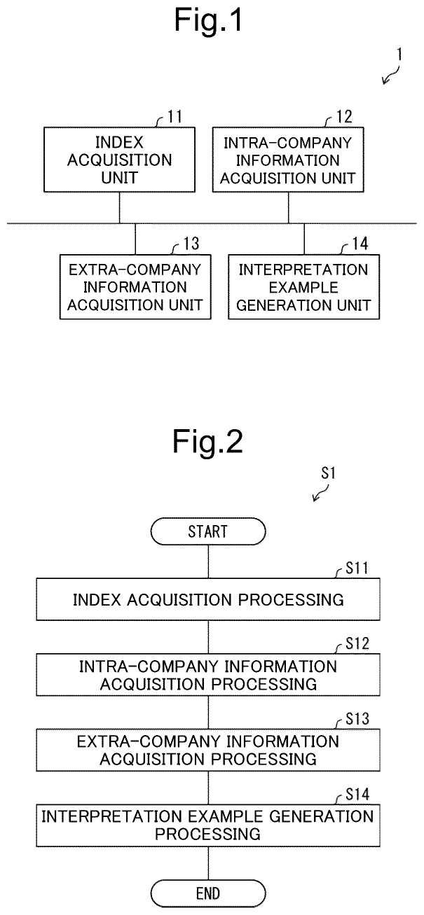

A configuration of an information processing system 1 will be described with reference to FIG. 1. FIG. 1 is a block diagram illustrating the configuration of the information processing system 1. As illustrated in FIG. 1, the information processing system 1 includes an index acquisition unit 11, an intra-company information acquisition unit 12, an extra-company information acquisition unit 13, and an interpretation example generation unit 14. The index acquisition unit 11 is an example of a configuration for achieving index acquisition means. The intra-company information acquisition unit 12 is an example of a configuration for achieving intra-company information acquisition means. The extra-company information acquisition unit 13 is an example of a configuration for achieving extra-company information acquisition means. The interpretation example generation unit 14 is an example of a configuration for achieving interpretation example generation means. The information processing system 1 may include a single device or may include a plurality of devices.

The index acquisition unit 11 acquires an index for managing accuracy of demand prediction related to an object segment including a plurality of products handled by an object company. The object company is a company that handles a plurality of products, and is a company that has introduced the information processing system 1 in order to manage accuracy of demand prediction related to the plurality of products. The object company may be, for example, a manufacturer that manufactures the plurality of products, a retailer that sells the plurality of products to consumers, or an intermediate distributor (so-called wholesaler) that intermediates the plurality of products between the manufacturer and the retailer, but is not limited to these.

Segments are categories in which a plurality of products is classified from a predetermined viewpoint, and may be, for example, brands, distribution channels, or regions where the plurality of products is sold, but are not limited to these. The object segment is a segment for which the index is to be acquired. The object segment may be, for example, a segment specified by a user among a plurality of segments, or may be a segment to be noted determined in advance, but is not limited to this.

The demand prediction is to predict demand for a product. The demand prediction may be performed by a computer by using an optional technology, or may be manually performed by an expert. The accuracy of the demand prediction refers to how close a demand prediction value indicating a result of the demand prediction is to a demand result value indicating a result of the demand. The accuracy of the demand prediction is higher as an error of the demand prediction is smaller. The error of the demand prediction is a difference between the demand prediction value and the demand result value.

The index for managing the accuracy of the demand prediction related to the object segment is an index that can be calculated based on the demand prediction value and/or the demand result value related to each product included in the object segment.

The index may include, for example, an index indicating an error rate of the demand prediction in the object segment, an index indicating a tendency of the error of the demand prediction in the object segment, and an index indicating an added value of the demand prediction in the object segment, but is not limited to these.

The intra-company information acquisition unit 12 acquires intra-company information related to an object segment inside an object company. For example, the intra-company information may include information related to activities performed by the object company with respect to the object segment.

The extra-company information acquisition unit 13 acquires extra-company information related to an object segment outside an object company. For example, the extra-company information may include general-purpose information independent of the object company with respect to the object segment.

The interpretation example generation unit 14 generates, as an interpretation example of an index, a sentence including a factor based on intra-company information and extra-company information related to an error of demand prediction, by using a large language model. For example, the “factor based on intra-company information and extra-company information related to an error of demand prediction” may include an intra-company or extra-company event that may be the factor causing the error of the demand prediction. For example, the interpretation example generation unit 14 may cause the interpretation example to be output from the large language model by generating a prompt including the index, the intra-company information, and the extra-company information and inputting the prompt to the large language model. For example, the interpretation example generation unit 14 may additionally train the large language model by using the intra-company information and the extra-company information. In this case, the interpretation example generation unit 14 may cause the interpretation example to be output from the large language model by inputting the prompt including the index to the additionally trained large language model. For example, the interpretation example generation unit 14 may add the intra-company information and the extra-company information to a knowledge base. In this case, the interpretation example generation unit 14 may cause the interpretation example to be output from the large language model by searching the knowledge base for information related to the index and inputting a prompt including a search result and the index to the large language model.

### (Effects of Information Processing System 1)

As described above, the information processing system 1 adopts the configuration including the index acquisition unit 11 that acquires an index for managing accuracy of demand prediction related to an object segment including a plurality of products handled by an object company, the intra-company information acquisition unit 12 that acquires intra-company information related to the object segment inside the object company, the extra-company information acquisition unit 13 that acquires extra-company information related to the object segment outside the object company, and the interpretation example generation unit 14 that generates, as an interpretation example of the index, a sentence including a factor based on the intra-company information and the extra-company information related to an error of the demand prediction, by using a large language model. Therefore, a user who refers to the interpretation example output from the information processing system 1 can know the interpretation example including the factor of the error in consideration of the intra-company information and the extra-company information with respect to the demand prediction in the object segment. As a result, according to the information processing system 1, it is possible to obtain an effect that analysis of the error of the demand prediction in the object segment can be supported.

### (Flow of Information Processing Method S1)

A flow of an information processing method S1 will be described with reference to FIG. 2. For example, in a case where the above-described information processing system 1 includes at least one processor, the at least one processor may execute the information processing method S1. FIG. 2 is a flowchart illustrating the flow of the information processing method S1. As illustrated in FIG. 2, the information processing method S1 includes index acquisition processing S11, intra-company information acquisition processing S12, extra-company information acquisition processing S13, and interpretation example generation processing S14.

In the index acquisition processing S11, at least one processor (for example, the index acquisition unit 11) acquires an index for managing accuracy of demand prediction related to an object segment including a plurality of products handled by an object company. Details of the index acquisition processing S11 are as described for the index acquisition unit 11, and thus, detailed description of the index acquisition processing S11 will not be repeated.

In the intra-company information acquisition processing S12, at least one processor (for example, the intra-company information acquisition unit 12) acquires intra-company information related to the object segment inside the object company. Details of the intra-company information acquisition processing S12 are as described for the intra-company information acquisition unit 12, and thus, detailed description of the intra-company information acquisition processing S12 will not be repeated.

In the extra-company information acquisition processing S13, at least one processor (for example, the extra-company information acquisition unit 13) acquires extra-company information related to the object segment outside the object company. Details of the extra-company information acquisition processing S13 are as described for the extra-company information acquisition unit 13, and thus, detailed description of the extra-company information acquisition processing S13 will not be repeated.

In the interpretation example generation processing S14, at least one processor (for example, the interpretation example generation unit 14) generates, as an interpretation example of the index related to the object segment acquired in the index acquisition processing S11, a sentence including a factor based on the intra-company information and the extra-company information related to an error of the demand prediction, by using a large language model. Details of the interpretation example generation processing S14 are as described for the interpretation example generation unit 14, and thus, detailed description of the interpretation example generation processing S14 will not be repeated.

### (Effects of Information Processing Method S1)

As described above, the information processing method S1 adopts the configuration including the index acquisition processing S11 in which at least one processor acquires an index for managing accuracy of demand prediction related to an object segment including a plurality of products handled by an object company, the intra-company information acquisition processing S12 in which at least one processor acquires intra-company information related to the object segment inside the object company, the extra-company information acquisition processing S13 in which at least one processor acquires extra-company information related to the object segment outside the object company, and the interpretation example generation processing S14 in which at least one processor generates, as an interpretation example of the index, a sentence including a factor based on the intra-company information and the extra-company information related to an error of the demand prediction, by using the large language model. Therefore, according to the information processing method S1, effects similar to those of the information processing system 1 can be obtained.

### SECOND EXAMPLE EMBODIMENT

A second example embodiment that is an example of the example embodiments of the present disclosure will be described in detail with reference to the drawings. Components that have the same functions as the components described in the above-described example embodiment are denoted by the same reference signs, and description of the components will be appropriately omitted. An application range of each technology adopted in the present example embodiment is not limited to the present example embodiment. In other words, each technology adopted in the present example embodiment can also be adopted in another example embodiment included in the present disclosure within a range in which no particular technical problem occurs. Each technology illustrated in each of the drawings referred to for describing the present example embodiment can also be adopted in another example embodiment included in the present disclosure within a range in which no particular technical problem occurs.

### (Configuration of Information Processing System 1A)

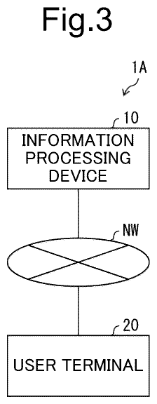

FIG. 3 is a block diagram illustrating a configuration of an information processing system 1A. The information processing system 1A is a system that supports analysis of an error of demand prediction. As illustrated in FIG. 3, the information processing system 1A includes an information processing device 10 and a user terminal 20. The information processing device 10 and the user terminal 20 are communicably connected via a communication line NW. Although a specific configuration of the communication line NW is not limited to the present example embodiment, the communication line NW is, as an example, a wireless local area network (LAN), a wired LAN, a wide area network (WAN), a public line network, a mobile data communication network, or a combination of these.

The information processing device 10 functions as a server that provides a service for analyzing an error of demand prediction for each segment in an object company. For example, the information processing device 10 may be a stationary computer, but is not limited to this. The user terminal 20 is a terminal used by a user who uses the above service in the object company. The user terminal 20 may be, for example, a notebook personal computer, a smartphone, or a tablet, but is not limited to these. The user who uses the user terminal 20 may be, for example, a user who manages the segment. The user may also be a user who has little knowledge related to the demand prediction. The user may also be a user who has knowledge related to the demand prediction.

### (Configuration of Information Processing Device 10)

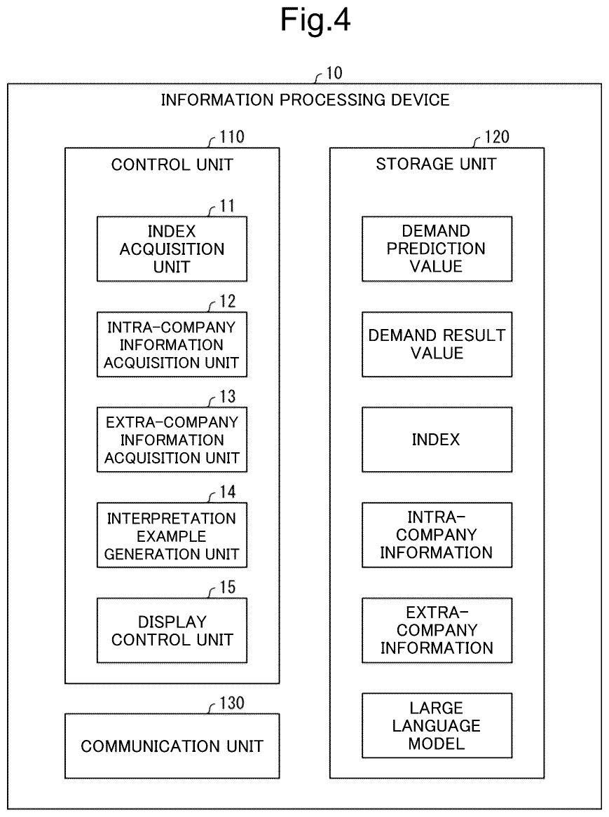

FIG. 4 is a block diagram illustrating a configuration of the information processing device 10. As illustrated in FIG. 4, the information processing device 10 includes a control unit 110, a storage unit 120, and a communication unit 130. The control unit 110 integrally controls each unit of the information processing device 10. The storage unit 120 stores various types of information referred to by the control unit 110. The communication unit 130 communicates with a device (for example, the user terminal 20) outside the information processing device via the communication line NW. The communication unit 130 transmits data supplied from the control unit 110 to another device, and supplies data received from another device to the control unit 110.

### (Functional Block Included in Control Unit 110)

The control unit 110 includes a display control unit 15 in addition to the index acquisition unit 11, the intra-company information acquisition unit 12, the extra-company information acquisition unit 13, and the interpretation example generation unit 14 included in the information processing system 1. The display control unit 15 is an example of a configuration for achieving display control means.

The index acquisition unit 11 is configured as follows in addition to being configured similarly to the functional block having the same name provided in the information processing system 1. For example, the index acquisition unit 11 may acquire a time series of indices in a predetermined period in the past. Detailed specific examples of the indices acquired by the index acquisition unit 11 in the present example embodiment will be described below.

The intra-company information acquisition unit 12 and the extra-company information acquisition unit 13 are configured similarly to the functional blocks having the same names provided in the information processing system 1. Detailed specific examples of information acquired by the intra-company information acquisition unit 12 and the extra-company information acquisition unit 13 in the present example embodiment will be described below.

The interpretation example generation unit 14 is configured as follows in addition to being configured similarly to the interpretation example generation unit 14 provided in the information processing system 1. For example, an interpretation example generated by the interpretation example generation unit 14 further includes one or both of a situation of an error of demand prediction and a proposal for a response to the error of the demand prediction, in addition to including a factor based on intra-company information and extra-company information related to the error of the demand prediction. For example, the “situation of an error of demand prediction” may include information such as a magnitude of the error, a tendency of the error such as overforecast or underforecast, and a change in these. The “proposal for a response to the error of the demand prediction” may include an example of a response that a user can take with respect to the error.

The display control unit 15 displays, on a display unit 250 of the user terminal 20 to be described below, a screen including an index acquired by the index acquisition unit 11 and an interpretation example generated by the interpretation example generation unit 14 according to an operation for specifying an object segment. For example, in a case where the index acquisition unit 11 acquires a time series of indices in a predetermined period, the display control unit 15 may display, on the display unit 250, a screen including a graph obtained by plotting the time series of the indices and an interpretation example. The display unit 250 of the user terminal 20 is an example of a display device to be a display destination of the screen by the display control unit 15.

### (Information Stored in Storage Unit 120)

The storage unit 120 stores various types of information to be referred to by the control unit 110. Examples of such information include a demand prediction value, a demand result value, an index, intra-company information, extra-company information, and a large language model. Some or all of these pieces of information may be stored in an external device different from the information processing device 10.

### (Demand Prediction Value)

The demand prediction value indicates a result of demand prediction related to each of a plurality of products handled by an object company. For example, the demand prediction value is a value representing demand predicted in a future unit period, and may be a predicted sales amount, a predicted sales quantity, or the like. In a case where it is assumed that the unit period is, for example, one week, the storage unit 120 may store, for example, identification information of the product, a future period (for example, the second week of April 2024), and a demand prediction value (for example, the predicted sales quantity of 120) in the period in association with each other. The unit period is not limited to one week, and may be one day, one month, one quarter, one year, or the like, but is not limited to these. The demand prediction value may be additionally stored in the storage unit 120 each time demand prediction is performed for a new future period.

### (Demand Result Value)

The demand result value indicates a past result of demand related to each of a plurality of products handled by an object company.

For example, the demand result value is a value representing demand in a past unit period, and may be, as an example, a result value of a sales amount, a result value of a sales quantity, or the like. In a case where it is assumed that the unit period is, for example, one week, the storage unit 120 may store, for example, identification information of the product, a past period (for example, the first week of April 2024), and a demand result value (for example, the result value of the sales quantity of 100) in the period in association with each other. The unit period is not limited to one week, and may be, for example, one day, one month, one quarter, or one year, but is not limited to these. The demand result value may be additionally stored in the storage unit 120 each time a demand result value is obtained for a new past period.

### (Index)

The index is an index for managing accuracy of demand prediction related to an object segment including a plurality of products handled by an object company. The index includes, for example, some or all of a mean absolute percentage error (MAPE), a forecast-Bias (f-Bias) rate, and a forecast value added (FVA). However, the index is not limited to these.

### (MAPE)

The MAPE is an index representing an error rate of demand prediction with respect to demand results of a plurality of products, and is used as an index for evaluating accuracy of the demand prediction. As an example, the MAPE is an average value of absolute values of values each of which is obtained by dividing a difference between a demand prediction value and a demand result value of each of the plurality of products by the demand result value.

For example, in a case where an object segment includes n products p_1, p_2, . . . p_n (n is a natural number of 1 or more), the MAPE related to the object segment is calculated by the following Expression (1) as an example. In Expression (1), y_i is a demand result value in an object unit period (hereinafter, also described as an object period) of a product p_i, and ∧y_i is a demand prediction value in the object period of the product p_i. An expression “_i” in “p_i”, “y_i”, and the like represents an “index i as a subscript”. An expression “∧y_i” represents a “hatted y_i”. As a variation of the MAPE, ∧y_i (demand prediction value) may be applied as a denominator instead of y_i (demand result value).

$$\begin{matrix}[ Expression 1 ] & \\ MAPE = \frac{100}{n} {\sum }_{i = 1}^{n} \vert \frac{{\hat{y}}_{i} - {y}_{i}}{{y}_{i}} \vert & ( 1 )\end{matrix}$$

### (Weighted MAPE)

The MAPE is not limited to the above Expression (1), and may be information obtained from a value obtained by weighting an error rate of a demand prediction value for each product with respect to a demand result value of the product according to the demand result value of the product. Hereinafter, such MAPE is also referred to as “weighted MAPE” or “WAPE”.

The weighted MAPE (WAPE) of the n products p_1, p_2, . . . p_n is calculated by the following Expression (2) as an example.

$$\begin{matrix}[ Expression 2 ] & \\ WAPE = 100 {\sum }_{i = 1}^{n} \{ \frac{{y}_{i}}{{\sum }_{j = 1}^{n} {y}_{j}} \cdot \vert \frac{{\hat{y}}_{i} - {y}_{i}}{{y}_{i}} \vert \} & ( 2 )\end{matrix}$$

(f-Bias Rate)

An f-Bias rate is an index representing a tendency of an error of a demand prediction value with respect to a demand result value.

The “tendency of an error” refers to a tendency of the demand prediction value to be higher or lower than the demand result value. In the f-Bias rate, a logic habit or a change in a market on which demand prediction is based appears. For example, the f-Bias rate of the n products p_1, p_2, . . . p_n included in the object segment is calculated by the following Expression (3) as an example. In Expression (3), y_i is the demand result value in the object period of the product p_i, and ∧y_i is the demand prediction value in the object period of the product p_i. As a variation of the f-Bias rate, a time unit of n times may be applied instead of the n products.

$$\begin{matrix}[ Expression 3 ] & \\ f - Bias rate = \frac{{\sum }_{i = 1}^{n} ( {\hat{y}}_{i} - {y}_{i} )}{{\sum }_{i = 1}^{n} {y}_{i}} & ( 3 )\end{matrix}$$

### (FVA)

An FVA is an index for evaluating an added value of demand prediction on an amount basis. The FVA is information for measuring whether adopted demand prediction generates value by comparing the adopted demand prediction with simple demand prediction. The simple demand prediction may be, for example, prediction in which a past demand result value (for example, a sales result value of a previous week) is directly used as a demand prediction value (for example, a demand prediction value of a next week). The FVA of the n products p_1, p_2, . . . p_n is calculated by the following Expression (4) as an example. In Expression (4), y_(i, k) is a demand result value in an object period k of the product p_i, and y_(i, k-x) is a demand result value in an optional period k-x (x is an integer of 1 or more) before the object period k of the product p_i. A demand prediction value in the object period k of the product p_i is represented by ∧y_(i, k). A unit price of the product p_i is represented by u_i.

$$\begin{matrix}[ Expression 4 ] & \\ FVA = ( \vert {y}_{i , k - x} - {y}_{i , k} \vert - \vert {\hat{y}}_{i , k} - {y}_{i , k} \vert ) \cdot {u}_{i} & ( 4 )\end{matrix}$$

### (Intra-Company Information)

As described above, the intra-company information is information obtained in an object company, and may be information specific to the object company. For example, the intra-company information may include information indicating a promotion performed in the object company for some or all of a plurality of products included in an object segment. The intra-company information may further include some or all of product information, a demand prediction value, a demand result value, and a distribution result value related to the plurality of products included in the object segment.

The information indicating the promotion may be, for example, information including an activity for promoting sales of a corresponding product and a period during which the activity is performed. The product information related to the object segment may be product information related to each of some or all of the plurality of products included in the object segment. The product information related to each product may include a price, an attribute, and the like of the product.

The demand prediction value related to the object segment may be a demand prediction value related to each of some or all of the plurality of products included in the object segment, or may be a demand prediction value in the entire object segment (that is, a sum of demand prediction values of the products). The demand result value related to the object segment may be, for example, a demand result value related to each of some or all of the plurality of products included in the object segment, or may be a demand result value in the entire object segment (that is, a sum of demand result values of the products). The demand prediction value or the demand result value may be information for each of retail sales, wholesale shipping, and manufacturer shipping. The distribution result value related to the object segment may be the number of distribution destinations (for example, the number of stores) to which each of some or all of the plurality of products included in the object segment is distributed. For example, the distribution result value related to the object segment may be a result value in the entire object segment (that is, a sum of distribution result values of the products). However, the intra-company information is not limited to the above-described example.

The intra-company information may be updated to the latest information at predetermined timings, or the latest information may be added. The intra-company information may be information in which items and values indicating the above-described various types of information are associated, or may be a document (for example, a journal or the like in the object company) including a natural language sentence that can include the above-described various types of information.

### (Extra-Company Information)

As described above, the extra-company information is information obtained from outside an object company, and may be general-purpose information independent of the object company. For example, the extra-company information may include one or both of economic trend information related to an object segment and social change information in an industry related to the object segment. The extra-company information may further include one or both of a change in regulations related to the industry and information indicating an external environment of the industry. For example, the change in the regulations related to the industry may be price revision. For example, the information indicating the external environment of the industry may be an external variable such as weather information, an exchange rate, or the number of foreign visitors to Japan. However, the extra-company information is not limited to the above-described example.

The extra-company information may be updated to the latest information at predetermined timings, or the latest information may be added. The extra-company information may be information in which items and values indicating the above-described various types of information are associated, or may be a document (for example, a journal of the industry or a journal related to the external environment) including a natural language sentence that can include the above-described various types of information.

### (Large Language Model)

The large language model is a deep learning model generated to execute a natural language processing task. For example, the large language model may be a trained general-purpose large language model, or may be a model obtained by fine-tuning such a general-purpose large language model. For example, the large language model may be a model that executes a sentence generation task, and that outputs a generated natural language sentence with a prompt by the natural language sentence as an input.

### (Configuration of User Terminal 20)

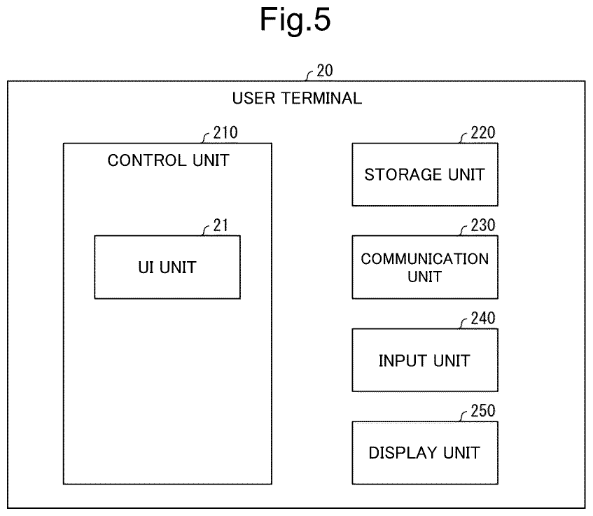

FIG. 5 is a block diagram illustrating a configuration of the user terminal 20. As illustrated in FIG. 5, the user terminal 20 includes a control unit 210, a storage unit 220, a communication unit 230, an input unit 240, and the display unit 250. The control unit 210 integrally controls each unit of the user terminal 20. The storage unit 220 stores various types of information referred to by the control unit 210. The communication unit 230 communicates with a device (for example, the information processing device 10) outside the user terminal 20 via the communication line NW. The communication unit 230 transmits data supplied from the control unit 210 to another device, and supplies data received from another device to the control unit 210.

The input unit 240 is a configuration for receiving an input to the user terminal 20, and may include, as an example, an input device such as a keyboard, a mouse, a touch panel, a camera, and a microphone. The display unit 250 is a configuration for displaying a screen output from the user terminal 20, and may include, as an example, a display. The input unit 240 and the display unit 250 may be integrally formed as a touch panel or the like. One or both of the input unit 240 and the display unit 250 are not limited to being built in the user terminal 20, and may be connected to the outside via an interface such as a universal serial bus (USB), for example.

The control unit 210 includes a user interface (UI) unit 21. The UI unit 21 provides a user interface for using a service for analyzing an error of demand prediction. For example, the UI unit 21 receives an operation of a user for using the service and transmits the operation to the information processing device 10. In a case where the user terminal 20 receives a screen related to the service from the information processing device 10, the UI unit 21 displays the received screen on the display unit 250. For example, the UI unit 21 may be achieved by executing an application program for using the service, which is stored in the storage unit 220. The application program may be an application dedicated to the service. In a case where the service is achieved as a web service, the application program may be a general-purpose web browser.

### (Flow of Information Processing Method S1A)

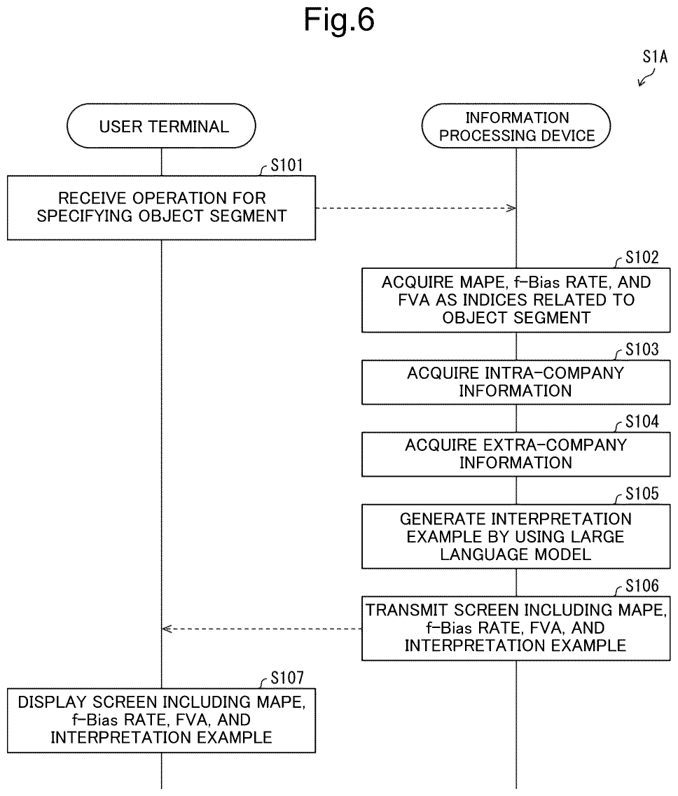

The information processing system 1A configured as described above executes an information processing method SIA. FIG. 6 is a flowchart illustrating a flow of the information processing method SIA. As illustrated in FIG. 6, the information processing method SIA includes steps S101 to S107.

In step S101, the UI unit 21 of the user terminal 20 receives an operation of a user for specifying an object segment via the input unit 240. For example, the operation of the user may be an operation for selecting the object segment from a list of segments displayed on the display unit 250, but is not limited to this. The operation of the user may further include an operation for specifying a past predetermined period (for example, a predetermined year, a predetermined month, and a start date and an end date of the period) for which an index related to the object segment is to be displayed. The UI unit 21 transmits, to the information processing device 10, information (for example, information indicating the object segment and information indicating the predetermined period) indicated by the received operation.

In step S102, the index acquisition unit 11 of the information processing device 10 acquires an MAPE, an f-Bias rate, and an FVA as indices related to the object segment. For example, the index acquisition unit 11 may acquire a time series of the indices in the predetermined period by reading the time series of the indices from the storage unit 120. The index acquisition unit 11 may acquire the time series of the indices in the predetermined period by calculating the time series of the indices based on a demand prediction value and a demand result value stored in the storage unit 120. In a case where the operation for specifying the predetermined period is not received in step S101, a predetermined period determined in advance may be applied.

In step S103, the intra-company information acquisition unit 12 acquires intra-company information. For example, the intra-company information acquisition unit 12 may acquire the intra-company information related to the predetermined period by reading the intra-company information from the storage unit 120.

In step S104, the extra-company information acquisition unit 13 acquires extra-company information. For example, the extra-company information acquisition unit 13 may acquire the extra-company information related to the predetermined period by reading the extra-company information from the storage unit 120.

Steps S102 to S104 are not necessarily executed in this order, and may be executed in a different order or partially or entirely in parallel.

In step S105, the interpretation example generation unit 14 generates, with reference to the time series of the indices, the intra-company information, and the extra-company information, sentences as an interpretation example by using a large language model. The interpretation example includes a situation of an error of demand prediction, a factor based on the intra-company information and the extra-company information related to the error of the demand prediction, and a proposal for a response to the error of the demand prediction.

For example, the interpretation example generation unit 14 may acquire sentences output from the large language model as the interpretation example by generating a prompt including the time series of the indices, the intra-company information, the extra-company information, and cases and inputting the prompt to the large language model. Examples of the cases included in the prompt include a case of the time series of the indices for an optional segment, a case of the intra-company information, a case of the extra-company information, and a case of the sentences as the interpretation example. Examples of the case of the sentences as the interpretation example include a case of the situation of the error of the demand prediction, a case of the factor related to the demand prediction, and a case of the proposal for the response to the error of the demand prediction.

In step S106, the display control unit 15 generates a screen including the time series of the indices and the interpretation example. The display control unit 15 transmits the screen to the user terminal 20.

In step S107, the UI unit 21 of the user terminal 20 displays the received screen on the display unit 250.

### (Screen Example)

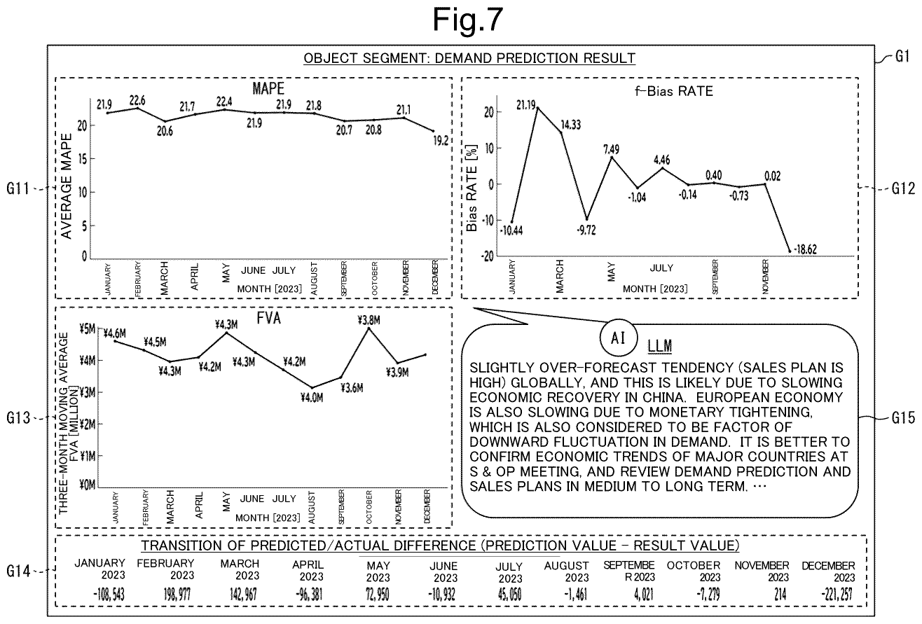

FIG. 7 is a diagram illustrating an example of the screen displayed on the display unit 250 in step S107. As illustrated in FIG. 7, a screen example G1 is an example of a screen indicating a demand prediction result of the object segment. The screen example G1 includes regions G11 to G15. The region G11 includes a graph indicating a transition of the MAPE in the predetermined period of the object segment. The region G12 includes a graph indicating a transition of the f-Bias rate in the predetermined period of the object segment. The region G13 includes a graph indicating a transition of the FVA in the predetermined period of the object segment. The region G14 includes a table indicating a transition of a predicted/actual difference in the predetermined period of the object segment. The predicted/actual difference is a value obtained by subtracting a demand result value from a demand prediction value.

The region G15 includes the sentences as the interpretation example. Among the sentences as the interpretation example, a sentence “slightly over-forecast tendency (sales plan is high) globally” indicates a situation of a prediction error (in other words, the error of the demand prediction). With such a sentence indicating the situation of the prediction error, even a user with little knowledge related to the demand prediction can easily grasp the situation of the prediction error indicated by the graphs and the table illustrated in the regions G11 to G14. Among the sentences as the interpretation example, sentences “this is likely due to the slowing economic recovery in China. The European economy is also slowing due to monetary tightening, which is also considered to be a factor of downward fluctuation in demand” indicate a factor of the prediction error. With such sentences indicating the factor of the prediction error, even a user with little knowledge related to the demand prediction can easily grasp the factor of the prediction error indicated in the regions G11 to G14 based on the intra-company information and the extra-company information. Among the sentences as the interpretation example, a sentence “It is better to confirm economic trends of major countries at S & OP meeting, and review the demand prediction and the sales plan in the medium to long term” indicates a proposal for a response to the prediction error. With such a sentence indicating the proposal for the response to the prediction error, even a user with little knowledge can easily respond to the prediction error. With the screen example G1, it is possible to provide support to a user having knowledge related to the demand prediction, such as reducing missing of information to be considered for analyzing the error of the demand prediction, shortening time to collect and organize information, and increasing consideration time.

### (First Modification)

The interpretation example generation unit 14 may generate the interpretation example as follows instead of inputting the prompt including the intra-company information, the extra-company information, and the indices to the large language model. In the present modification, the intra-company information and the extra-company information acquired by the intra-company information acquisition unit 12 and the extra-company information acquisition unit 13 are added to a knowledge base (not illustrated). As a result, the knowledge base is updated to the latest state. The knowledge base may be stored in the storage unit 120 or may be stored in an external device different from the information processing device 10. The interpretation example generation unit 14 may search for information related to the time series of the indices from the knowledge base updated to the latest state, and input a prompt including a search result and the time series of the indices to the large language model. As a result, sentences as the interpretation example are output from the large language model. For example, in the present modification, in step S103 or S104, processing of adding the acquired intra-company information and extra-company information to the knowledge base may be further performed. Steps S103 and S104 do not need to be performed after the reception of the operation for specifying the object segment (S101), and may be executed at an optional time point (for example, periodically).

### (Second Modification)

The interpretation example generation unit 14 may generate the interpretation example as follows instead of inputting the prompt including the intra-company information, the extra-company information, and the indices to the large language model. In the present modification, the large language model is additionally trained by using the intra-company information and the extra-company information acquired by the intra-company information acquisition unit 12 and the extra-company information acquisition unit 13. As a result, the large language model is updated to the latest state. The interpretation example generation unit 14 may input the prompt including the time series of the indices to the large language model updated to the latest state. As a result, sentences as the interpretation example are output from the large language model. For example, in the present modification, in step S103 or S104, processing of additionally training the large language model by using the acquired intra-company information and extra-company information may be further performed. Steps S103 and S104 do not need to be performed after the reception of the operation for specifying the object segment (S101), and may be executed at an optional time point (for example, periodically).

### (Effects of Information Processing System 1A)

As described above, the information processing system 1A adopts the configuration in which sentences as an interpretation example further include one or both of a situation of an error of demand prediction and a proposal for a response to the error of the demand prediction. Therefore, according to the information processing system 1A, in addition to the effects provided by the information processing system 1, it is possible to obtain effects that it is possible to easily grasp the situation of the error of the demand prediction and easily respond to the error of the demand prediction.

The information processing system 1A also adopts the configuration further provided with the display control unit 15 that displays a screen including an index for managing accuracy of demand prediction related to an object segment and an interpretation example of the index on the display device according to an operation for specifying the object segment. Therefore, according to the information processing system 1A, in addition to the effects provided by the information processing system 1, it is possible to obtain an effect that, for example, a user who manages the object segment can recognize, while browsing the index for managing the accuracy of the demand prediction related to the object segment, the interpretation example of the index.

The information processing system 1A also adopts the configuration in which intra-company information includes information indicating a promotion performed by an object company for the object segment. Therefore, according to the information processing system 1A, in addition to the effects provided by the information processing system 1, it is possible to obtain an effect that it is possible to present, to the user, the interpretation example in consideration of a possibility that the promotion performed by the object company is related as a factor of an error of the demand prediction related to the object segment.

The information processing system 1A also adopts the configuration in which extra-company information includes one or both of economic trend information related to the object segment and social change information in an industry related to the object segment. Therefore, according to the information processing system 1A, in addition to the effects provided by the information processing system 1, it is possible to obtain an effect that it is possible to present, to the user, the interpretation example in consideration of a possibility that the economic trend information related to the object segment, the social change information in the industry related to the object segment, and the like are related as the factors of the error of the demand prediction related to the object segment.

The information processing system 1A also adopts the configuration in which the intra-company information includes some or all of product information, a demand prediction value, a demand result value, and a distribution result value related to the object segment. Therefore, according to the information processing system 1A, in addition to the effects provided by the information processing system 1, it is possible to obtain an effect that it is possible to present, to the user, an interpretation example in consideration of a possibility that the product information, the demand prediction value, the demand result value, the distribution result value, and the like related to the object segment are related as the factors of the error of the demand prediction related to the object segment.

The information processing system 1A also adopts the configuration in which the extra-company information includes one or both of a change in regulations in the industry related to the object segment and information indicating an external environment of the industry. Therefore, according to the information processing system 1A, in addition to the effects provided by the information processing system 1, it is possible to obtain an effect that it is possible to present, to the user, an interpretation example in consideration of a possibility that the change in the regulations in the industry related to the object segment and the information indicating the external environment of the industry are related as the factors of the error of the demand prediction related to the object segment.

The demand prediction has an error from results due to various factors. Therefore, it is important to analyze the error of the demand prediction. A user who manages a segment including a plurality of products desires to analyze the error of the demand prediction in the segment. However, JP 2015-118412 A does not describe analyzing the error of the demand prediction. There is a problem that specialized knowledge is needed for analysis of such an error of the demand prediction. Even in the case of having the specialized knowledge, the analysis of such an error of the demand prediction has problems that information to be considered may be missing, it takes time to collect and organize information, it may be difficult to take sufficient consideration time, and the like. Therefore, there is demand for a technology of supporting the analysis of the error of the demand prediction in the segment.

According to an exemplary aspect of the present disclosure, there is provided an exemplary effect that a technology of supporting analysis of an error of demand prediction in an object segment can be provided.

### [Achievement Example by Software]

Some or all of the functions of the information processing system 1, the information processing device 10, and the user terminal 20 (hereinafter, also described as “each of the above devices”) may be achieved by hardware such as an integrated circuit (IC chip) or may be achieved by software.

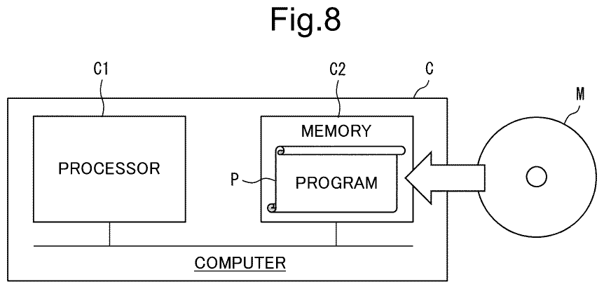

In the latter case, each of the above devices is achieved by, for example, a computer that executes a command of a program as software for achieving each function. An example of such a computer (hereinafter, described as a computer C) is illustrated in the drawing. FIG. 8 is a block diagram illustrating a hardware configuration of the computer C functioning as each of the above devices.

The computer C includes at least one processor C1 and at least one memory C2. A program P causing the computer C to operate as each of the above devices is recorded in the memory C2. In the computer C, by the processor C1 reading the program P from the memory C2 and executing the program P, each function of each of the above devices is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used.

The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### [Supplementary Note A]

The present disclosure includes technologies described in the following Supplementary Notes. However, the present disclosure is not limited to the technologies described in the following Supplementary Notes, and various modifications can be made within the scope described in the claims.

### (Supplementary Note A1)

An information processing system including:
index acquisition means for acquiring an index for managing accuracy of demand prediction related to an object segment including a plurality of products handled by an object company;
intra-company information acquisition means for acquiring intra-company information related to the object segment inside the object company;
extra-company information acquisition means for acquiring extra-company information related to the object segment outside the object company; and
interpretation example generation means for generating, as an interpretation example of the index, a sentence including a factor based on the intra-company information and the extra-company information related to an error of the demand prediction, by using a large language model.

### (Supplementary Note A2)

The information processing system according to Supplementary Note A1, in which the interpretation example further includes one or both of a situation of the error of the demand prediction and a proposal for a response to the error of the demand prediction.

### (Supplementary Note A3)

The information processing system according to Supplementary Note A1 or A2, further including display control means for displaying a screen including the index and the interpretation example on a display device according to an operation for specifying the object segment.

### (Supplementary Note A4)

The information processing system according to any one of Supplementary Notes A1 to A3, in which the intra-company information includes information indicating a promotion performed by the object company for the object segment.

### (Supplementary Note A5)

The information processing system according to any one of Supplementary Notes A1 to A4, in which the extra-company information includes one or both of economic trend information related to the object segment and social change information in an industry related to the object segment.

### (Supplementary Note A6)

The information processing system according to any one of Supplementary Notes A1 to A5, in which the intra-company information includes some or all of product information, a demand prediction value, a demand result value, and a distribution result value related to the object segment.

### (Supplementary Note A7)

The information processing system according to any one of Supplementary Notes A1 to A6, in which the extra-company information includes one or both of a change in regulations in the industry related to the object segment and information indicating an external environment of the industry.

### [Supplementary Note B]

The present disclosure includes technologies described in the following Supplementary Notes. However, the present disclosure is not limited to the technologies described in the following Supplementary Notes, and various modifications can be made within the scope described in the claims.

### (Supplementary Note B1)

An information processing method including:
index acquisition processing in which at least one processor acquires an index for managing accuracy of demand prediction related to an object segment including a plurality of products handled by an object company;
intra-company information acquisition processing in which the at least one processor acquires intra-company information related to the object segment inside the object company;
extra-company information acquisition processing in which the at least one processor acquires extra-company information related to the object segment outside the object company; and
interpretation example generation processing in which the at least one processor generates, as an interpretation example of the index, a sentence including a factor based on the intra-company information and the extra-company information related to an error of the demand prediction, by using a large language model.

### (Supplementary Note B2)

The information processing method according to Supplementary Note B1, in which the interpretation example further includes one or both of a situation of the error of the demand prediction and a proposal for a response to the error of the demand prediction.

### (Supplementary Note B3)

The information processing method according to Supplementary Note B1 or B2, further including display control processing in which the at least one processor displays a screen including the index and the interpretation example on a display device according to an operation for specifying the object segment.

### (Supplementary Note B4)

The information processing method according to any one of Supplementary Notes B1 to B3, in which the intra-company information includes information indicating a promotion performed by the object company for the object segment.

### (Supplementary Note B5)

The information processing method according to any one of Supplementary Notes B1 to B4, in which the extra-company information includes one or both of economic trend information related to the object segment and social change information in an industry related to the object segment.

### (Supplementary Note B6)

The information processing method according to any one of Supplementary Notes B1 to B5, in which the intra-company information includes some or all of product information, a demand prediction value, a demand result value, and a distribution result value related to the object segment.

### (Supplementary Note B7)

The information processing method according to any one of Supplementary Notes B1 to B6, in which the extra-company information includes one or both of a change in regulations in the industry related to the object segment and information indicating an external environment of the industry.

### [Supplementary Note C]

The present disclosure includes technologies described in the following Supplementary Notes. However, the present disclosure is not limited to the technologies described in the following Supplementary Notes, and various modifications can be made within the scope described in the claims.

### (Supplementary Note C1)

An information processing program for causing a computer to function as an information processing system, the computer being caused to function as:
index acquisition means for acquiring an index for managing accuracy of demand prediction related to an object segment including a plurality of products handled by an object company;
intra-company information acquisition means for acquiring intra-company information related to the object segment inside the object company;
extra-company information acquisition means for acquiring extra-company information related to the object segment outside the object company; and
interpretation example generation means for generating, as an interpretation example of the index, a sentence including a factor based on the intra-company information and the extra-company information related to an error of the demand prediction, by using a large language model.

### (Supplementary Note C2)

The information processing program according to Supplementary Note C1, in which the interpretation example further includes one or both of a situation of the error of the demand prediction and a proposal for a response to the error of the demand prediction.

### (Supplementary Note C3)

The information processing program according to Supplementary Note C1 or C2, in which the computer is further caused to function as display control means for displaying a screen including the index and the interpretation example on a display device according to an operation for specifying the object segment.

### (Supplementary Note C4)

The information processing program according to any one of Supplementary Notes C1 to C3, in which the intra-company information includes information indicating a promotion performed by the object company for the object segment.

### (Supplementary Note C5)

The information processing program according to any one of Supplementary Notes C1 to C4, in which the extra-company information includes one or both of economic trend information related to the object segment and social change information in an industry related to the object segment.

### (Supplementary Note C6)

The information processing program according to any one of Supplementary Notes C1 to C5, in which the intra-company information includes some or all of product information, a demand prediction value, a demand result value, and a distribution result value related to the object segment.

### (Supplementary Note C7)

The information processing program according to any one of Supplementary Notes C1 to C6, in which the extra-company information includes one or both of a change in regulations in the industry related to the object segment and information indicating an external environment of the industry.

### [Supplementary Note D]

The present disclosure includes technologies described in the following Supplementary Notes. However, the present disclosure is not limited to the technologies described in the following Supplementary Notes, and various modifications can be made within the scope described in the claims.

### (Supplementary Note D1)

An information processing system including at least one processor, the at least one processor executing:
index acquisition processing of acquiring an index for managing accuracy of demand prediction related to an object segment including a plurality of products handled by an object company;
intra-company information acquisition processing of acquiring intra-company information related to the object segment inside the object company;
extra-company information acquisition processing of acquiring extra-company information related to the object segment outside the object company; and
interpretation example generation processing of generating, as an interpretation example of the index, a sentence including a factor based on the intra-company information and the extra-company information related to an error of the demand prediction, by using a large language model.

The information processing system may further include a memory. The memory may store a program for causing the at least one processor to execute each of the processing.

### (Supplementary Note D2)

The information processing system according to Supplementary Note D1, in which the interpretation example further includes one or both of a situation of the error of the demand prediction and a proposal for a response to the error of the demand prediction.

### (Supplementary Note D3)

The information processing system according to Supplementary Note D1 or D2, in which
the at least one processor further executes
display control processing of displaying a screen including the index and the interpretation example on a display device according to an operation for specifying the object segment.

### (Supplementary Note D4)

The information processing system according to any one of Supplementary Notes D1 to D3, in which the intra-company information includes information indicating a promotion performed by the object company for the object segment.

### (Supplementary Note D5)

The information processing system according to any one of Supplementary Notes D1 to D4, in which the extra-company information includes one or both of economic trend information related to the object segment and social change information in an industry related to the object segment.

### (Supplementary Note D6)

The information processing system according to any one of Supplementary Notes D1 to D5, in which the intra-company information includes some or all of product information, a demand prediction value, a demand result value, and a distribution result value related to the object segment.

### (Supplementary Note D7)

The information processing system according to any one of Supplementary Notes D1 to D6, in which the extra-company information includes one or both of a change in regulations in the industry related to the object segment and information indicating an external environment of the industry.

### [Supplementary Note E]

The present disclosure includes technologies described in the following Supplementary Notes. However, the present disclosure is not limited to the technologies described in the following Supplementary Notes, and various modifications can be made within the scope described in the claims.

### (Supplementary Note E1)

A non-transitory recording medium recording an information processing program for causing a computer to function as an information processing system, the computer being caused to execute:
index acquisition processing of acquiring an index for managing accuracy of demand prediction related to an object segment including a plurality of products handled by an object company;
intra-company information acquisition processing of acquiring intra-company information related to the object segment inside the object company;
extra-company information acquisition processing of acquiring extra-company information related to the object segment outside the object company; and
interpretation example generation processing of generating, as an interpretation example of the index, a sentence including a factor based on the intra-company information and the extra-company information related to an error of the demand prediction, by using a large language model.

1. An information processing system comprising:
one or more memories storing instructions; and
one or more processors configured to execute the instructions to:
acquire an index for managing accuracy of demand prediction related to an object segment including a plurality of products handled by an object company;
acquire intra-company information related to the object segment inside the object company;
acquire extra-company information related to the object segment outside the object company; and
generate, as an interpretation example of the index, a sentence including a factor based on the intra-company information and the extra-company information related to an error of the demand prediction, by using a large language model.

2. The information processing system according to claim 1, wherein the interpretation example further includes one or both of a situation of the error of the demand prediction and a proposal for a response to the error of the demand prediction.

3. The information processing system according to claim 1, wherein the one or more processors are further configured to execute the instructions to:
display a screen including the index and the interpretation example on a display device according to an operation for specifying the object segment.

4. The information processing system according to claim 1, wherein the intra-company information includes information indicating a promotion performed by the object company for the object segment.

5. The information processing system according to claim 1, wherein the extra-company information includes one or both of economic trend information related to the object segment and social change information in an industry related to the object segment.

6. The information processing system according to claim 1, wherein the intra-company information includes some or all of product information, a demand prediction value, a demand result value, and a distribution result value related to the object segment.

7. The information processing system according to claim 1, wherein the extra-company information includes one or both of a change in regulations in an industry related to the object segment and information indicating an external environment of the industry.

8. The information processing system according to claim 1, wherein the large language model is a deep learning model trained to analyze the error and support decision making by identifying factors affecting forecast accuracy.

9. An information processing method comprising:
acquiring an index for managing accuracy of demand prediction related to an object segment including a plurality of products handled by an object company;
acquiring intra-company information related to the object segment inside the object company;
acquiring extra-company information related to the object segment outside the object company; and
generating, as an interpretation example of the index, a sentence including a factor based on the intra-company information and the extra-company information related to an error of the demand prediction, by using a large language model.

10. A non-transitory recording medium that records an information processing program for causing at least one processor to execute:
acquiring an index for managing accuracy of demand prediction related to an object segment including a plurality of products handled by an object company;
acquiring intra-company information related to the object segment inside the object company;
acquiring extra-company information related to the object segment outside the object company; and
generating, as an interpretation example of the index, a sentence including a factor based on the intra-company information and the extra-company information related to an error of the demand prediction, by using a large language model.
